(19) United States
(12) Patent Application Publication
(10) Pub. No.: US 2010/0182436 A1
(43) Pub. Date: Jul. 22, 2010

(54) VENUE PLATFORM

(75) Inventors: Bill Boman, Coppell, TX (US); Kenton Robert Holcomb, Azle, TX (US); Joao B. Alencar, Keller, TX (US)

Correspondence Address: RG & ASSOCIATES, 1103 TWIN CREEKS, STE. 120, ALLEN, TX, 75013, US

(73) Assignee: CORE ACTION GROUP, INC., Grapevine, TX (US)

(21) Appl. No.: 12/690,774

(22) Filed: Jan. 20, 2010

Related U.S. Application Data
(60) Provisional application No. 61/145,799, filed on Jan. 20, 2009.

(51) Int. Cl. H04N 5/232; G06K 9/00; H04N 5/225; G06K 7/01; G01S 19/37; G01S 5/02

(52) U.S. Cl. 348/207.1; 382/103; 348/211.4; 340/10.41; 342/357.06; 342/450; 348/E05.043; 348/E05.024

(57) ABSTRACT

The present disclosure is configured to perform a method of recording the movement of a user during a sporting event session. The method may include detecting the user's movement during a first portion of the sporting event session, and recording the user's movement via a recording device upon the user's first location being confirmed via a location determination device. Examples of sporting event sessions may include, BMX biking, race tracks, motocross, skate boarding, skiing, snowboarding, etc.

### CROSS-REFERENCE TO RELATED APPLICATIONS

The instant application claims priority from U.S. Provisional Patent Application Ser. No. 61/145,799, titled CORE ACTION VENUE PLATFORM, filed 20 Jan. 2009, the entire contents of which are incorporated by reference herein.

### BACKGROUND OF THE DISCLOSURE

Action Sports has become a big-business on the pro-level. Events like the X-Games and the Dew Tour and athletes like Tony Hawk, Dave Mirra and Shaun White are making their respective sports more mainstream. The rise in popularity has trickled down to the many Action Sports venues that are in business worldwide. Venues include (but are not limited to) skateparks, motocross tracks, BMX tracks, and Ski Resorts which are now full of talented local participants who aren't at the pro-level, but are exhibiting skills that compare to some of the pros. Current sports venues are limited in that they have no video product and no way for the user to access, view or share out video footage of their activity at the venue. Sports venues typically have well defined participant areas that are generally controlled, separated and sometimes fenced off from other public areas which limits access for traditional video production by friends, family or otherwise. The CORE Venue Platform of the present disclosure, was designed to document and capture these up-and-comers as they work their way up from the local level on up the ladder of notoriety. The platform gives entertainment value, as well as a marketing platform, from which advertisers can get their brand to their target audiences via the content playback displays (projector/screen, TV's, & mobile phones). All CORE Action Venue Users must update their respective venue liability waivers to include photography release.

### BRIEF SUMMARY OF THE DISCLOSURE

The present disclosure provides a system, method and computer readable storage medium. In one embodiment, a method of recording the movement of a user during a sporting event session comprises detecting the user's movement during a first portion of the sporting event session, and recording the user's movement via at least one first recording device upon the user's first location being confirmed via a location determination device.

In another embodiment, an apparatus configured to record the movement of a user during a sporting event session comprises a detector configured to detect the user's movement during a first portion of the sporting event session and a recording device configured to record the user's movement upon the user's first location being confirmed via the location determination device.

In a further embodiment, a computer readable storage medium configured to store a computer program that when executed causes a processor to perform recording the movement of a user during a sporting event session, the processor being further configured to perform detecting the user's movement during a first portion of the sporting event session and recording the user's movement via at least one first recording device upon the user's first location being confirmed via a location determination device.

Example embodiments of the present disclosure may include a method of recording the movement of a user during a sporting event session. The method may include detecting the user's movement during a first portion of the sporting event session. The method may also include recording the user's movement via at least one first recording device upon the user's first location being confirmed via a location determination device.

Other example embodiments of the present disclosure may include an apparatus configured to record the movement of a user during a sporting event session. The apparatus may include a detector configured to detect the user's movement during a first portion of the sporting event session. The apparatus may also include a recording device configured to record the user's movement upon the user's first location being confirmed via the location determination device.

Further aspects of the disclosure will become apparent from consideration of the drawings and the ensuing descriptions of embodiments and alternate embodiments of the disclosure. A person skilled in the art will realize that other embodiments of the disclosure are possible and that the details of the disclosure can be modified in a number of respects, all without departing from the inventive concept. Thus, the following drawings and description are to be regarded as illustrative in nature and not restrictive.

### BRIEF DESCRIPTION OF THE DRAWINGS

FIG. 1 illustrates a system which includes on-site venue hardware inputs (1a), the CORE Venue Software and Processes which acquire the information provided by the hardware inputs (1b), and elements of the Video Output System (1c) according to one embodiment of the instant application;

FIG. 2 illustrates a web site application which includes CORE Web Servers and Database (2a), and a Content Retrieval and User Access Process (2b) according to one embodiment of the instant application;

FIG. 3a illustrates an overview of a venue environment according to one embodiment of the instant application;

FIG. 3b illustrates a cross section of a venue environment according to one embodiment of the instant application;

FIG. 4a illustrates another overview of a venue environment according to one embodiment of the instant application;

FIG. 4b illustrates another cross section of a venue environment according to one embodiment of the instant application;

FIG. 5 illustrates a photorealistic representation of the CORE Venue Platform according to one embodiment of the instant application;

FIG. 6a illustrates a further overview of a venue environment according to one embodiment of the instant application;

FIG. 6b illustrates a further cross section of a venue environment according to one embodiment of the instant application;

FIG. 7a illustrates yet another overview of a venue environment according to one embodiment of the instant application;

FIG. 7b illustrates yet another cross section of a venue environment according to one embodiment of the instant application;

FIG. 8a illustrates yet a further overview of a venue environment according to one embodiment of the instant application;

FIG. 8b illustrates yet a further cross section of a venue environment according to one embodiment of the instant application;

FIG. 9a illustrates still another overview of a venue environment according to one embodiment of the instant application; and

FIG. 9b illustrates still a further cross section of a venue environment according to one embodiment of the instant application.

### DETAILED DESCRIPTION

The instant application describes a CORE Venue Platform, which includes at least one of a front end software and a back end software. The Venue Applications of the application utilize a combination of Audio/Video (‘A/V’) technologies with Internet Protocol (‘IP’) hardware equipment and various Personal Identification and Location Devices (‘User ID Location Device’), such as, but not limited to, Global Positioning Systems (‘GPS’) with Personal ID Locator Beacon Tags via Satellite Communication and Radio Frequency Identification Systems (‘RFID’) with Personal RFID Tags and RFID Readers, (or other locating ID technology) to create Individual Video Production Recordings of any person wearing a CORE User ID Location Device linking the users video content to the individual, the end user. The venue software can then output this individual video content to a time-delayed (or real-time) venue display screen. Subsequently, the back end software, The Website Applications can automatically upload the individuals' video content to CORE Venue Servers and/or CORE action website for retrieval, viewing, editing and sharing at, www.COREaction.com, (or other selected and licensed websites) through the software applications and user interfaces of the present application. A purpose of the disclosure is to provide an interactive media integration, marketing platform and system to identify and capture a CORE Action user on video, playback the video on-site, and archive, batch, deliver and upload to the web, where the user then retrieves, edits, posts and shares his production.

One advantage of the CORE Venue Platform is the user will not only see his playbacks on the display screens, but can go home (or to any other location) and watch his video clips on his CORE Action profile on the Internet. They can then edit the selected clips together and add music to make a short video production that can be shared with friends and family through the website. Key elements of the CORE Venue Platform include the Audio/Video capturing system, utilizing Identification and Location Devices and CORE Software applications, the Venue Application and the Website Application, which are designed to enable one or more aspects of this process.

The CORE Action Venue Platform can be utilized in skateparks, ski reorts, motocross tracks or other action sports locations where video cameras will be set up in specific fixed and/or moving areas (areas determined to be of interest by CORE action, such as ramps, jumps, hills, finish lines or any other obstacle or position of choice) to capture the action while any ID location device (such as GPS, RFID, transponders, or other similar technology) locates and identifies users who are wearing an ID location device as they participate in action sports within a venue, creating Audio/Video files of the user. The file will be archived in any device described in this document and, in one embodiment, played back on a big display screen along with the users name and the CORE sponsors. The archived file is then sent to the CORE Web Server and then parsed out into the user's profile, which contains the user's personal information, contact information, and customizable features that allow the user to specify preferences on camera angles, and other adjustments of the CORE Venue Platform that conforms the system to the user's needs. Once inside the user's profile, they can edit the files into their own production to post and share on the Internet. The final video files may be automatically edited with various marketing and promotional information such as corporate branding and/or the participants name.

In other embodiments, multiple possible camera systems and combinations can be presented. For instance, a point of view camera can be attached to the user and/or the user's equipment (i.e. skateboard, bicycle, motorcycle, skis, snowboard, helmet, wrist, boots, golf bag, golf cart or other). Video cameras can fly overhead on zip-lines, which follow the user around the course or sections of the course. The user's location device will alert multiple cameras to engage when the user enters each camera's field of view, tripping off the other cameras as the user moves through the course, creating a continuous flowing video, or creating multiple clips that can later be put together. In outdoor scenarios, cameras and/or ID location readers can be mounted on various overhead structures, cables typical to sports or production environments, a blimp or other aerial devices. The ID location devices track the user as they move through the course. High speed video cameras can be used to capture the action and enable high-quality slow-motion playback. High resolution video cameras can be used for HD quality video content and pan/tilt/zoom (PTZ) video cameras can be used to follow a location ID device carried by a user.

The CORE Venue Platform provides a unique interactive experience for the venue participants, one that joins audio & video media integration with personal identification systems to individualize media production content for CORE Action member users.

This concert of multiple existing technologies and proprietary software connected by CORE Venue Platform Applications create a competitive advantage for not only the many venue owners who can be “Powered by CORE Action”, but also for the company's website www.COREaction.com, an action sports social network and video sharing website, as well as any other entity to whom CORE Action might license the technology.

The CORE Action Venue Software Applications are intended, in one embodiment, as an Interactive Marketing Tool to create additional brand recognition for many corporate sponsors within the respective venues Powered by ‘CORE Action’. The CORE Action Venue Experience is offered free to the end users within the venues who become members of CORE Actions website community where the member users will be able to retrieve, view, edit and share their individual video content with friends and family, and who are ultimately the corporate sponsors' preferred demographic.

The CORE Venue Platform is comprised of two controlling applications that CORE Action Group, Inc., has developed—the on-site Venue Application and the Website Application.

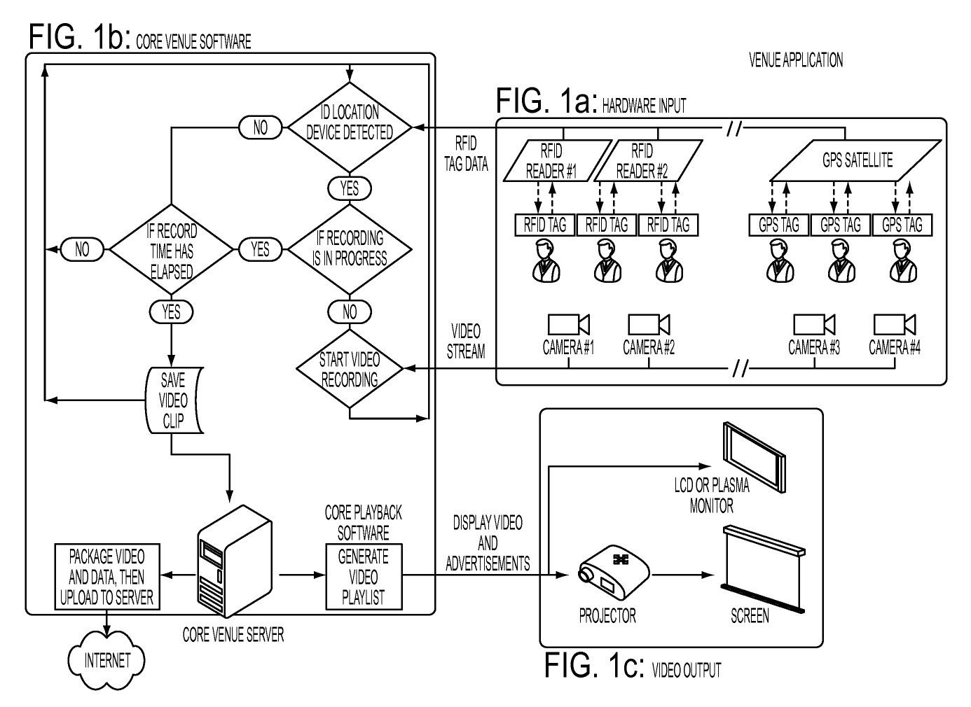

FIG. 1 illustrates a system which includes on-site venue hardware inputs (1a), the CORE Venue Software and Processes which acquire the information provided by the hardware inputs (1b), and elements of the Video Output System (1c) according to one embodiment of the instant application. FIG. 1a illustrates the on-site venue hardware inputs, whereby a CORE Action end user, being provided an ID location device tag or beacon, passes through a specified video initialization zone. The ID Location device reader or satellite communicates with the device tag to confirm its location and user ID and sends that information to the CORE Venue Server (FIG. 1b). The software described in FIG. 1b sends a signal to the video cameras to begin recording and the corresponding video clips captured by the camera system (or systems) are simultaneously sent to the CORE Venue Software (FIG. 1b) for processing. In an alternate embodiment the ID location data and the video data can be received and stored separately and matched up later in the process or retrieved directly at the venue itself via a user interface installed at the venue.

FIG. 1b illustrates the CORE Venue Software and Processes which acquires the information provided by the hardware inputs (FIG. 1a), the ID location device data (GPS, RFID, transponders or other similar technology), the Video Stream Data from the video camera, and processes it. The CORE software application identifies the ID location device input from FIG. 1a and creates an individual folder for each user that an input is received in the order received. The software attributes the incoming video to the individual user's folder in the preferred video format or alternate choice. The video may be saved in a compressed file format either through a specific video camera output format or by compression software.

This software application has special features and settings to allow continuation of a video recording by reception of additional read input confirmations by the ID location hardware. Software controls may be adjusted via IP Internet controls on-site or user controls to continue or terminate a video after a pre-determined amount of time (in seconds) after an additional read confirmation. It can also be extended to a preset maximum video length via software controls. When the user exits the read zone, as determined by a second confirmation from the location software, both sets of data (ID and Video) are transferred and processed by the CORE Venue Software, arriving at the CORE Venue Server. If the ID locator doesn't give a second response, the file will be put into a separate folder for review as to whether or not it should be discarded.

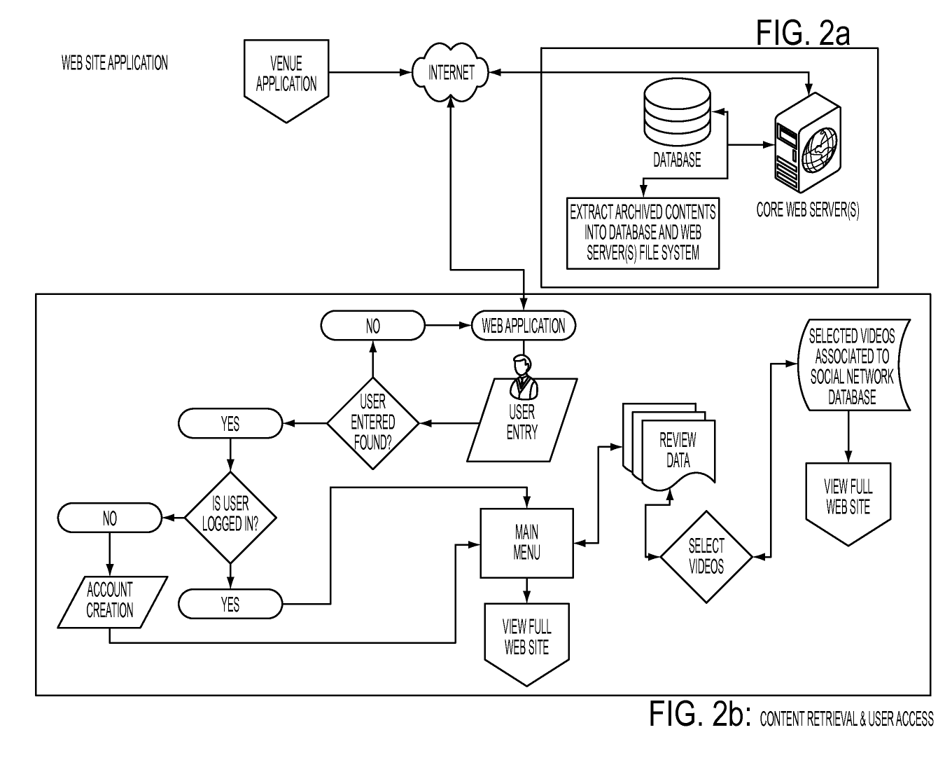

The CORE Playback Software generates a video playlist by searching for any video files (such as, but not limited to, MP4's, H264 compressed video, or any other video camera output format) in a directory to cue the file into the Video Output System (FIG. 1c) for on-site viewing. The CORE Venue Server packages the same video and data, and uploads that information to the CORE Web Servers (FIG. 2a) through the Internet.

In an alternate embodiment, the user only needs to be identified once as entering the read zone to have the cameras produce a video recording and send the two sets of data (ID and Video) on to arrive at the CORE Venue Server. Also, the ID locator could be picked up in a number of ways, including, but not limited to, single reads, multiple confirming reads, triangulating using multiple reads which all comprise the read zone, wherein cameras are positioned to produce a video. The cameras could also be motion-detector based, wherein the unit only produces video files when something passes in front of the unit. The cameras could also stream to a Digital Video Recorder (or similar device) using the ID location device (pinpointed in the read zone) as a timestamp to ID and mark the files for processing.

FIG. 1c represents elements of the Video Output System which will take the data output (video files, user's information, sponsors, advertisements) by the Server Software and Processes (FIG. 1b) and displays the video output and advertisements to the venue site (FIG. 1c) by way of projector and screen, LCD or plasma monitors, mobile phone, or any other display device.

FIG. 2 illustrates a web site application which includes CORE Web Servers and Database (2a), and a Content Retrieval and User Access Process (2b) according to one embodiment of the instant application. FIG. 2a shows the CORE Web Servers and Database which receives, extracts and archives the data generated through the internet from the Venue Application (FIG. 1) into the CORE Web Servers file system.

FIG. 2b illustrates the Content Retrieval and User Access Process whereby the same information extracted and archived by the CORE Web Servers and Database (FIG. 2a) is processed, identified and distributed for user retrieval. The user enters the web application (through www.COREaction.com or any other website or application chosen by CORE Action) and gains access to their account or creates an account (using the ID # given to them or the access password they've chosen). The user then gains entry to review their data and select or discard their videos, determining which clips the user wants to post on the website. Once the user chooses their videos to be shown on the site, they can use the sites social networking capabilities to share and display their video or video collections.

In alternate embodiments, the social network capabilities are not necessary, the user could collect his video clip and data for use as they see fit direct from the corresponding directories associated with each user.

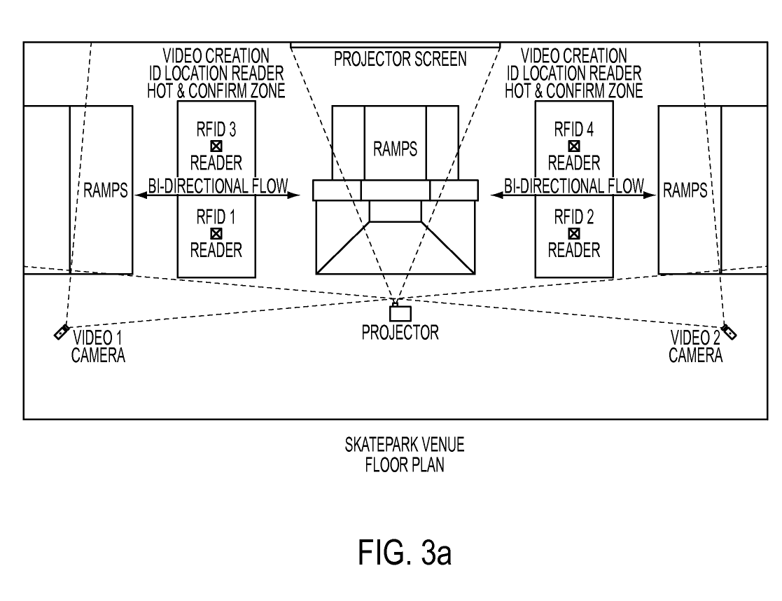

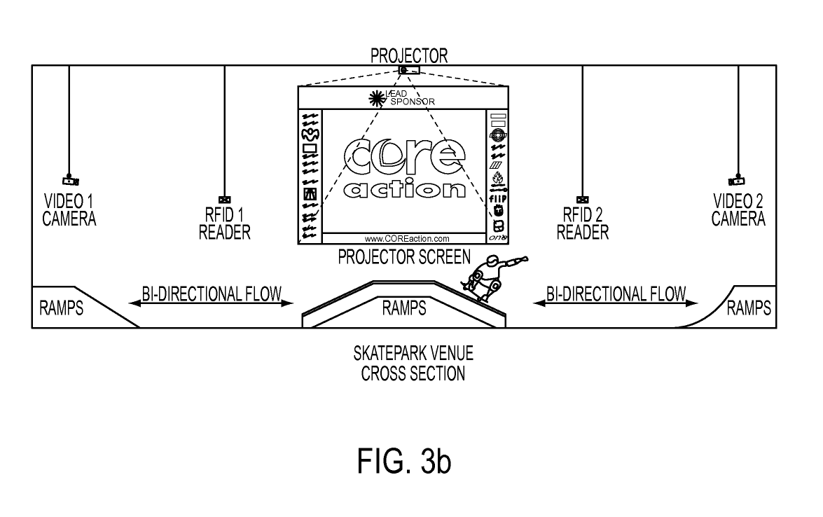

FIGS. 3a and 3b show an overview and cross section of a typical venue environment (in this case, a skate park). Also shown is potential placement of the hardware elements; the RFID readers, video cameras, projector and screen (described in FIG. 1a) in a typical skate park scene. The cross section shows a detail of the screen displaying the CORE branding and other sponsorship marketing aspects framing the user video content playback.

In other embodiments, the cameras can be anywhere within the venue grounds. For instance, the cameras can be mounted on the user themselves, or their equipment (helmet, body, equipment, gear). Cameras can be mounted, fixed, moving, panning, zooming, tracking, handheld, overview, close-up, high-speed, slow-motion, fish-eye, wide-angle and/or normal lens functionality.

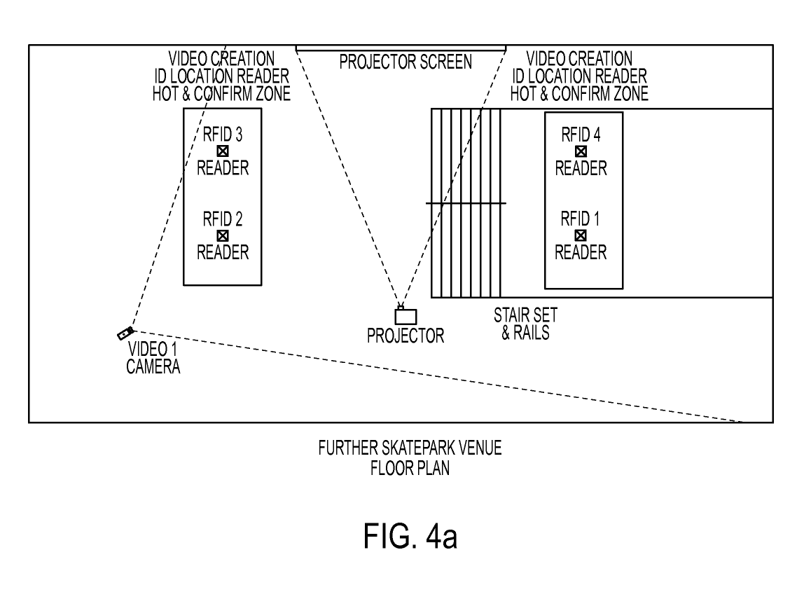

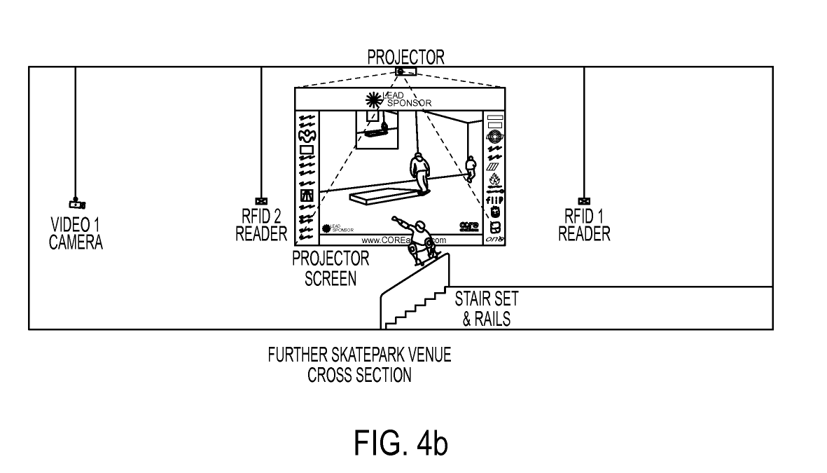

FIGS. 4a and 4b illustrate another possible scenario overview and cross section of a typical venue environment (in this case, another skate park obstacle and production area). Also shown is potential placement of the hardware elements, the RFID readers, video cameras, projector and screen (described in FIG. 1a) in a typical skate park scene. The cross section shows a detail of the screen displaying the Video Playback of a CORE user (in this case, another skater) as well as the CORE branding and other sponsorship marketing aspects.

In alternate embodiments, the venue can be temporary, or exist for a short time duration using a mobile version of the CORE Venue Platform. All the equipment, or any combination of the equipment described herein can be brought out to a location (such as a motocross tracks, BMX tracks, skate parks, gyms, arenas, parks, fairgrounds, or any other event venues).

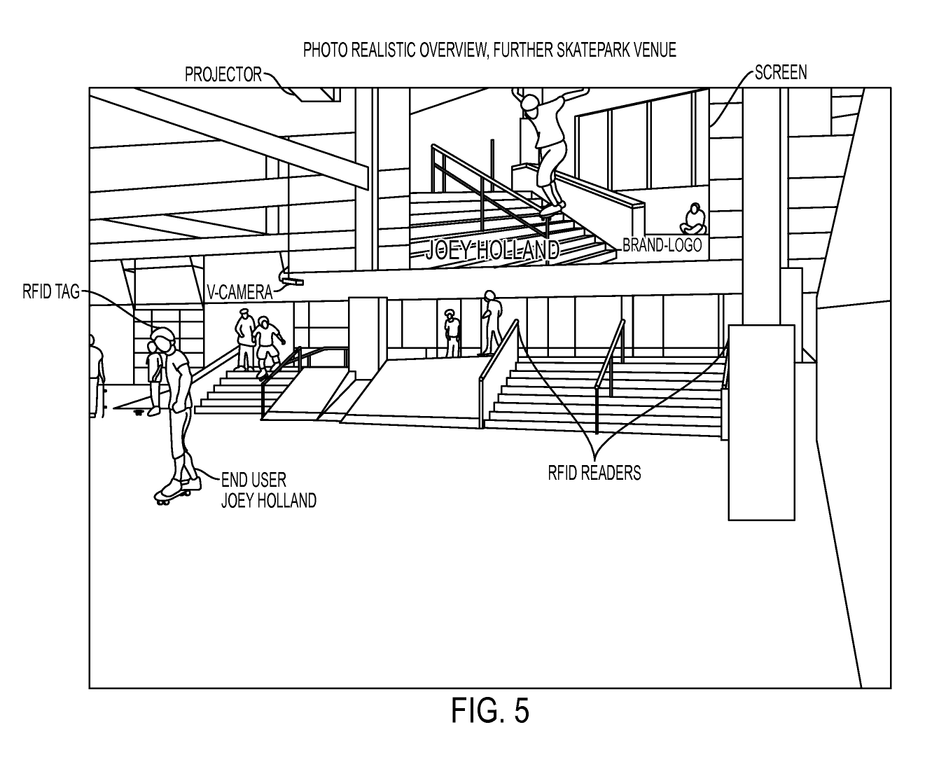

FIG. 5 shows a photorealistic representation of the CORE Venue Platform in action (similar to FIG. 4). The image shows the potential placement of a video camera, projector and display screen in a skate park venue. The skater (labeled Joey Holland) has just completed his run and passes through the system's ID Location readers (“hot zones”) while wearing an RFID tag (or other ID location device). The screen behind the skater shows a representation of the video playback of the user (labeled Joey Holland) displaying the video captured of the run just completed and saves the video file for user retrieval.

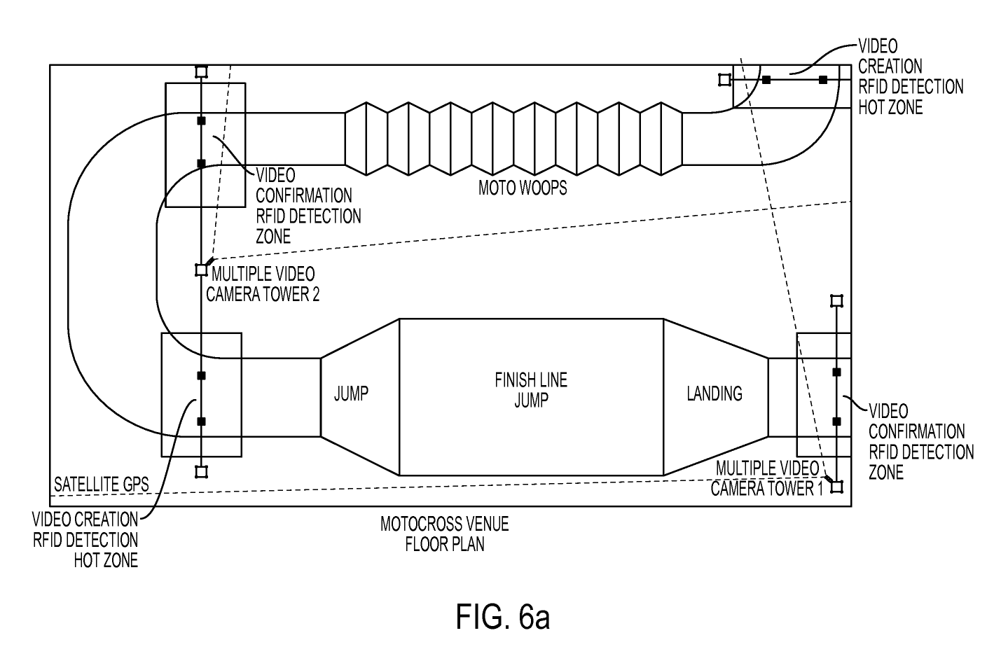

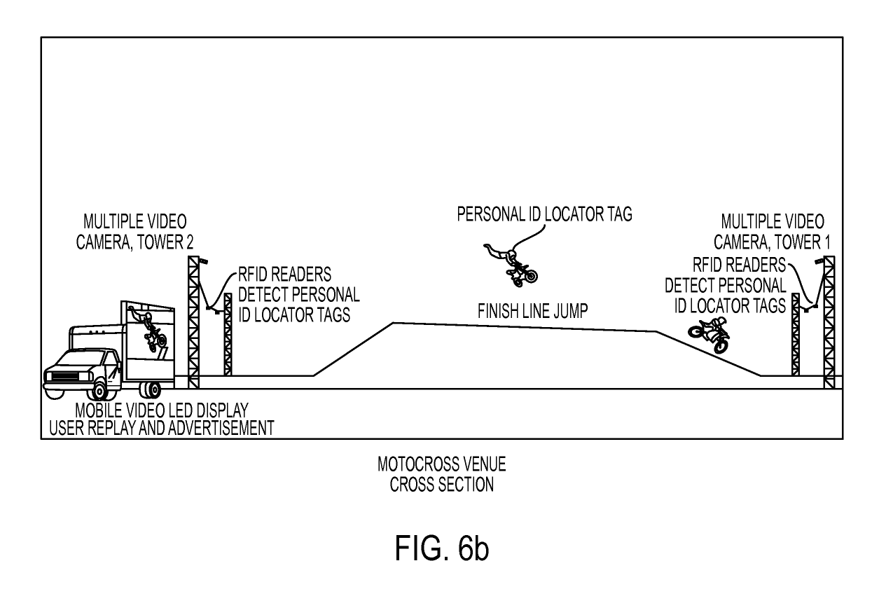

FIGS. 6a and 6b illustrate another possible scenario overview and cross section of a venue environment (in this case, a Motocross Track). Also shown is potential placement of the hardware elements, the RFID readers, the video cameras, digital screen mobile truck service for video playback and sponsorship (described in FIG. 1a). The cross section shows a detail of the mobile screen displaying the Video Playback of a CORE user (in this case, a MX Racer) as well as the CORE branding and other sponsorship marketing aspects.

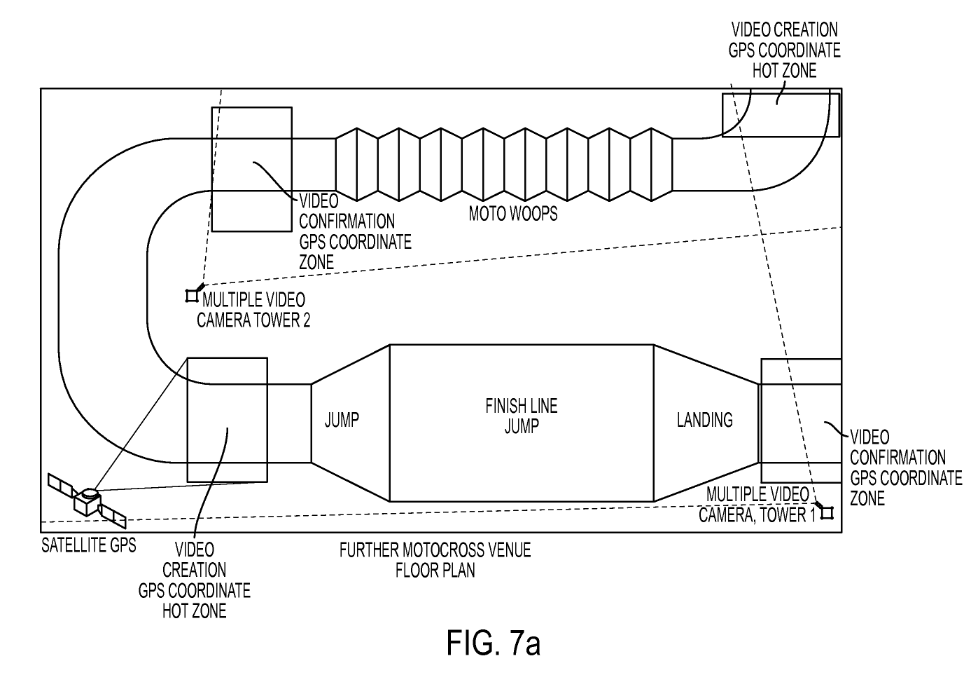

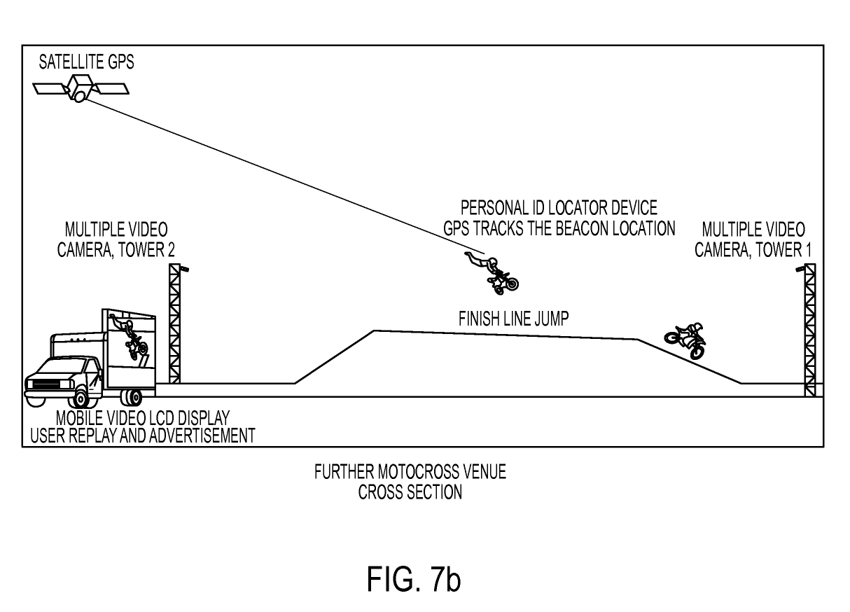

FIGS. 7a and 7b illustrate another possible scenario overview and cross section of a venue environment (in this case, a Motocross Track). Also shown are preset GPS coordinate hot zone areas and potential placement of the hardware elements, the video cameras, digital screen mobile truck service for video playback and sponsorship (described in FIG. 1a). The cross section shows a detail of the mobile screen displaying the Video Playback of a CORE user (in this case, a MX Racer) as well as the CORE branding and other sponsorship marketing aspects.

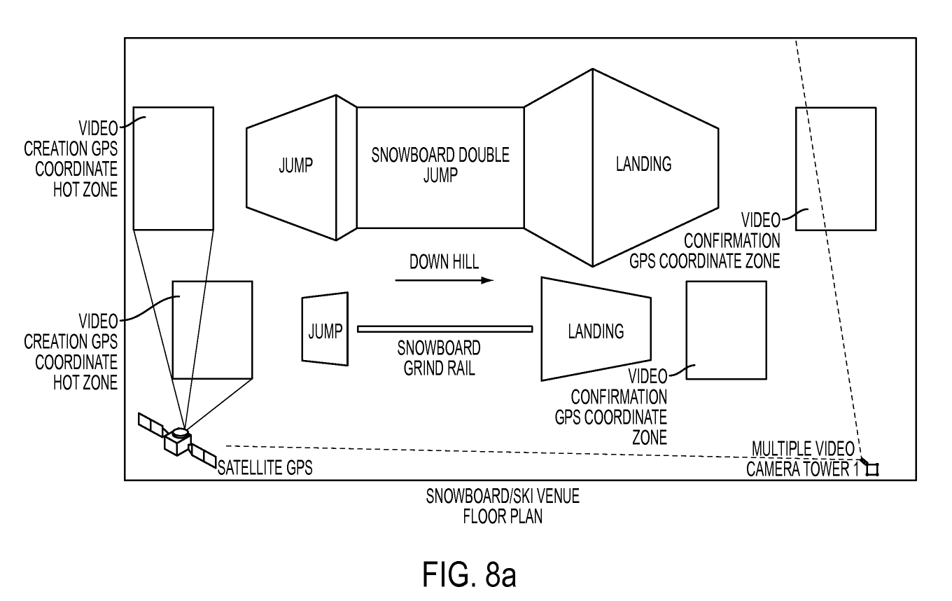

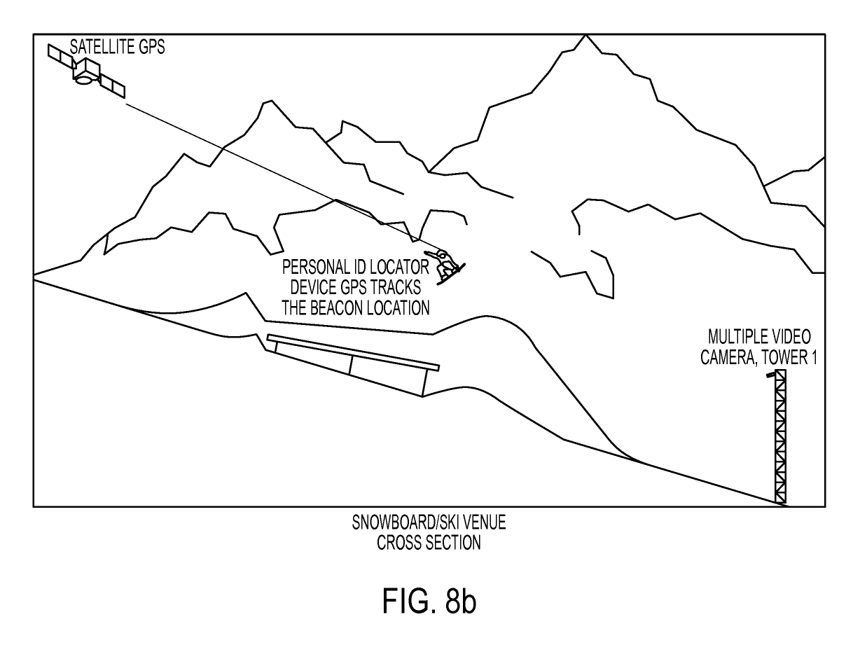

FIGS. 8a and 8b illustrate another possible scenario overview and cross section of a venue environment (in this case, a Snowboard/ski Resort Terrain Park). Also shown are preset GPS coordinate hot zone areas and placement of the hardware elements, video cameras, projector and screen (described in FIG. 1a). The cross section shows a detail of the screen displaying the Video Playback of a CORE user (in this case, Snowboarder) as well as the CORE branding and other sponsorship marketing aspects.

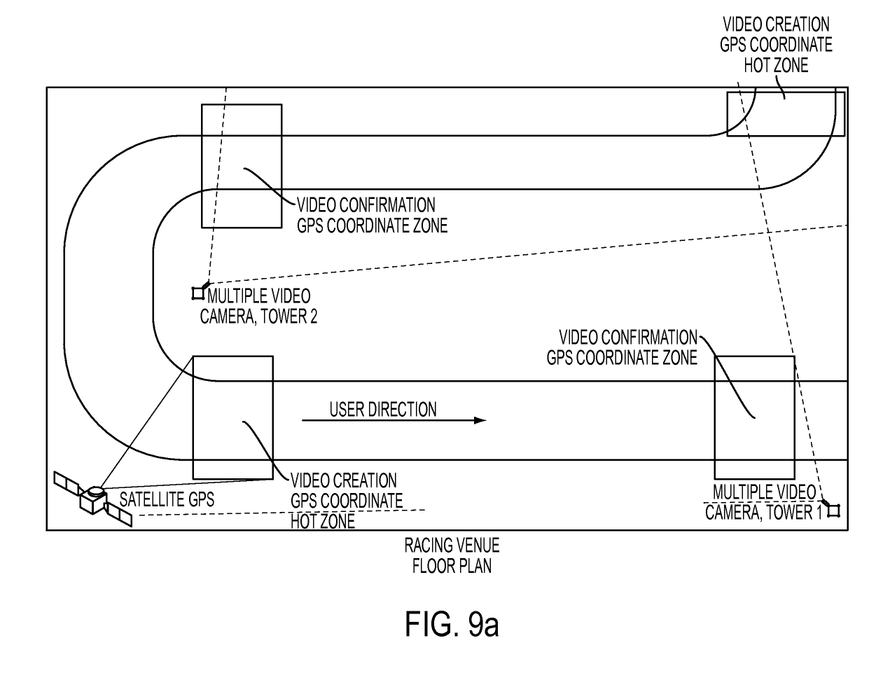

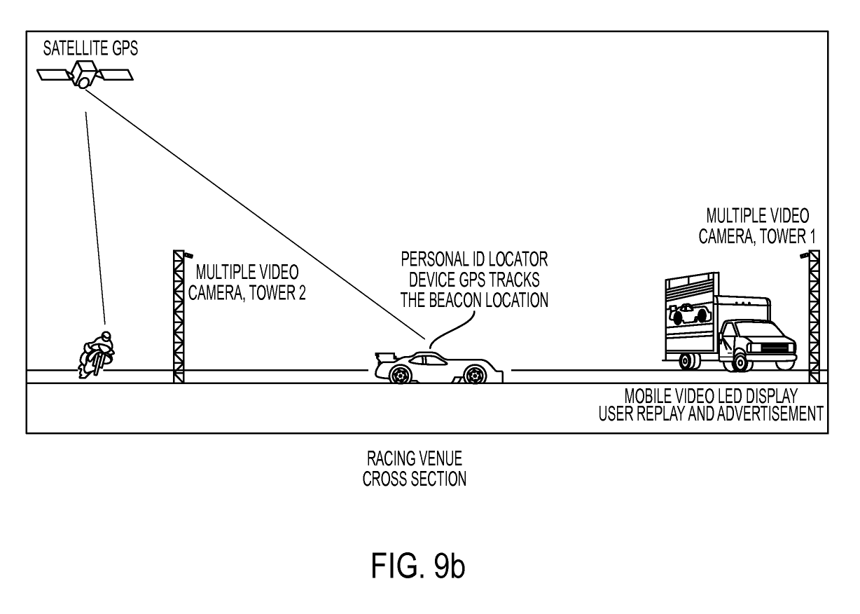

FIGS. 9a and 9b illustrate another possible scenario overview and cross section of a venue environment (in this case, a Snowboard/ski Resort Terrain Park). Also shown are preset GPS coordinate hot zone areas and placement of the hardware elements, video cameras, projector and screen (described in FIG. 1a). The cross section shows a detail of the screen displaying the Video Playback of a CORE user (in this case, Race Car & Superbike) as well as the CORE branding and other sponsorship marketing aspects.

Core Venue Applications

The Automatic Video Production Software, is a content-driven application used to communicate with and operate Audio/Video (‘A/V’) Recording Equipment with Internet Protocol (‘IP’) control capability and various Personal Identification and Location Devices (‘CORE User ID Location Devices’), such as, but not limited to, Global Positioning Systems (‘GPS’) with Personal ID Locator Beacon Tags via satellite communication (preferred outdoors) and Radio Frequency Identification Systems (‘RFID’) with Personal RFID Tags and RFID Readers (preferred indoors and outdoor capable), (or any other locating ID technology) to create Individual Video Production Recordings of any person wearing a CORE User ID Location Device linking each user's video content to the individual, the end user.

Within a venue, CORE Action's team would identify various video production areas for multiple venue system installations. With respect to a single venue system description, this team would identify the best video camera location and would locate the specific obstacle production area that CORE ID Location Read Devices (‘GPS’ or ‘RFID’) shall be situated to initialize and start a video recording of an individual user. These specific user video initialization locations where ID Location Device readers or GPS coordinate areas are defined are referred to ‘CORE Hot Zones,’ and the user video completion locations where ID Location Devices or GPS coordinate areas are defined is referred to as the ‘CORE confirmation Zones’.

These zones can be unidirectional, as described below, where the confirmation zone becomes the hot zone depending on direction of travel. Each system area may consist of one ID Location Device for each zone or a row or grid of ID location read devices or an enlarged GPS defined coordinate zone area that effectively enlarge the overall production area to contain multiple venue obstacles. When a user passes through a Hot Zone the CORE User ID Location Device will indentify the user and locate the user via the ID Location Tag (RFID or GPS, other) the user is provided upon entering the venue. This user ID location device verification is received by the CORE Venue Server which instructs the video camera or cameras to begin recording as described below.

Video Cameras (manual or IP controlled) automatically capture and record the users participating within the venue area into video files (standard video file types such as, but not limited to: AVI, MP4, FLV, MJPG) utilizing the CORE Venue Software. Video Content primarily consisting of action at 30 frames per second (FPS) up to very high speeds exceeding 200 FPS, and may be captured in standard quality (‘VGA’) or 720 p High Definition (‘HD’) and up to 1080 p HD. In addition, the CORE Venue Software provides an interface to view and handle the automatic capture of video (analog or digital), and to associate the two based on the location in which the ID location device (RFID tag, GPS beacon, other) is detected. The venue software can attribute multiple video feeds as additional user ID location devices are detected from other venue participants enter the hot zones, and associate each device tag to their own video production based on what order they pass into a video creation CORE hot zone. CORE software is designed to maximize hi-speed video with multiple video feeds from a single camera without frame drop (referring to a reduction in the cameras frames per second recording capability) producing a smooth video playback for each additional user entering the production area. High speed video cameras can be used for productions where slow motion replay is desired to facilitate smooth motion playbacks, otherwise 30 FPS exceeds the human eye's capability to perceive frame drop and motion appears very smooth. The system is capable of making a single feed video of multiple ID location tags passing through a hot zone within milliseconds of each other and saving the same video of all the users (very close to each other) in each users ID folder, as well as, creating multiple feed video (individual videos) of users passing through the hot zones in excess of the time preset via CORE venue software input.

One embodiment has static video cameras placed in a stationary location pointed directly at the participant area and can be tested or controlled via IP (Internet Protocol) addresses from any world wide web access terminal, including focus, zoom and resolution settings. Additionally, optional (PTZ) cameras can enable the units to be panned, tilted and zoomed through IP controls. Video Camera equipment may be AC powered or powered over the Ethernet via CAT5 or CAT6 cable alone. The venue software is capable of adding multiple video cameras to capture a single defined production area with ID location hot zones. These additional video cameras can be coordinated to film at the same time, to select the best camera to use if the direction is determined to be the frontal view by the venue software system, and can also provide user controls to select their preferred video angle from various venue area control panels, personal settings that are all linked to the individuals personal ID, as described below.

Another embodiment would allow an unlimited number of cameras, but as an example 6 cameras that would enable panoramic view video with dynamic pan functions. Another embodiment would allow the video cameras to automatically follow or track a CORE User ID Location Device as it moves through the venue that would be controlled automatically by the inherent capability to triangulate an ID Device tag location (RFID or GPS, other) within a space, verify direction and speed; an algorithm available through various RFID and GPS systems. The production area coordinate data is then associated with various inputs required to control a PTZ video cameras movement, pan and tilt angle functions. This system can also support multiple cameras set to follow additional ID location devices that may enter a hot zone while the first camera follows movement of the first device.

The Venue Software Settings and Controls, provide the venue application with many sophisticated settings and controls to enhance the user experience and improve the video production quality. The CORE software can virtually eliminate false reads and false video creation once a tag is identified, by determining the direction of a user moving through or standing near the hot zone of the production area, actions that may not be intended to create a video. If the user is moving lateral to the flow of the production obstacle and accidentally passes through the hot zone or if users are simply standing in the hot zone the User ID Location Devices will sense the direction is wrong as only the initial ID location devices will acquire a read verifying the direction is incorrect and will discard the video. If the initial read direction is determined to be correct the CORE software also has the ability to distinguish a successful user run through the production area and a failed attempt. This is accomplished by a second set of CORE User ID Location Devices beyond the obstacle being filmed that provide a confirmation of the ID device letting the system know a user has successfully passed through the area and saves the video.

Furthermore, the software has various settings to control the length of a video recording after a device tag is confirmed by an additional device tag is read this allows the ability to extend video recordings for an adjustable and/or pre-determined amount of time. The automated controls are based on the continued detection of a single device tag, within a specified time frame setting, for a particular user who continues successfully their run back and forth through the production hot zones, which is customizable through the CORE Venue Software and can be altered to fit the different venue locations through software inputs made during the installation and may be changed over the Internet via IP controls. This feature has an additional setting that is also adjustable to limit the total length of a video receiving additional confirmed reads to a max video file size at the companies discretion. Even more important than being able to extend the length of a users run and video, is the function to allow the users flow to be bi-directional. The second set of readers described for confirmation also can serve as the initial read for video creation. This function allows the system to be bi-directional. A user may approach the production obstacle from either flow direction and the software acts the same. It also would allow the system to be utilized on many different types of obstacles within venues, as many venue areas require a unidirectional flow such as a half pipe, bowl, jump box, spine, manual pad to name only a few obstacles.

The Automatic Video Playback Software, an application which allows on-site playback, automatic file editing and archiving of the Audio/Video files created by the CORE Venue Software, described above. The system will detect new video files which are copied into a specific playlist directory through a directory listing and adds all new files to a que which plays them automatically in the order the video files are made to a display device (monitor, LED, Plasma, large projector/screen or mobile phone), then discards the files at the end of the day or other time frame. User control panels consisting of a small switch panel connected to the venue server via a CAT 5 or 6 cable, or other wired or wireless connection means allows additional user controls from within the venue. A user can select additional video cameras for a particular production obstacle area to change the vantage point for recording via a camera number button switch on the control panel that is linked to their personal ID location tag device simply by their approximation to the control panel and its ID location read terminal connected to the panel. After a video is automatically played on the venue screen, a user can also select a video replay button switch or a video delete button switch on the user control panel that can retrieve and replay the user's last video clip and send it back to the venue video projector screens current order of videos to be played from the playlist. A user can also choose to delete the last video from the playlist and their personal folder on the venue server, they can even select to save their videos but not have them sent to the display screen if that is the user preference all from the user control panel and ID locator terminal.

Advertising to corporate and industry sponsors can appear on the large projector/screens at each production area within each venue. This advertising content (brand logos or video commercial media) will be uploaded to the venue server via the Internet, from the company's production department, that will be played on the projector screen within the venue between user participant video clips and also may be branded around the video projection screen window during a user video clip, creating many hours of potential brand impressions for sponsors. The software handles the display of advertising and other forms of media and can automatically edit the actual video files with end user identification (name or username, or even opt to not include their name) and add corporate sponsor logos automatically embedded into the digital video file which can stay embedded in the files. Any overlays, logos, brands and/or user names are superimposed onto the video through specific camera software which excepts a preloaded overlay or can be edited onto the video file through an additional process in the playback software which adds the overlay, as well as, poll the database for a user name and associate link the user ID to the corresponding video file. This provides brand recognition and impression every time it is viewed on the www.COREaction.com website and on whatever viewing platform it is incorporated within the future through a separate licensing agreement.

Core Website Applications

The Automatic Video Content Delivery Software, will take all of the collected videos for a particular time period (hour, day, week, month, year) and compress them into one archive file this is achieved by a script which associates user ID directories and lists all newly created video files and combines them into one file with a 3rd party compression software. The script process continues to upload the file via a File Transfer Protocol (FTP) using a 3rd party FTP client on CORE's web servers. After successfully transferring, the file is decompressed and the contents are processed to extract the necessary data. All extracted data is then put into a database that is later used for user access to the files via a web site.

The Automatic Video Content Retrieval Software, to access and share the content, the user then visits the website and enters their assigned ID number. They are then asked if they are an existing CORE member, if not, they have the option of creating a membership. If the end user does have an existing account they will proceed to login with their credentials. The associated videos that are relevant to the user's ID are united with the corresponding CORE member account. The user is then presented with a list of all video files collected from any venue based on the data provided by the applications. Videos can be reviewed and selected by the user to be published on their personal profile and the public video section of CORE Action's website (or any site chosen by CORE Action). The users then have the option of sharing the videos with friends and family.

The Alternate Video Content Retrieval Software, to access video content within the venue itself, simply allows access to the CORE Venue Servers to manually copy data to various media devices, such as, DVD's, CD's, Jump Drives, Flash Drives, etc, to be provided to the end user within the venue.

Example embodiments of the present application also include a method of processing recorded video of a user participating in a sporting event session. The method may include detecting video data has been created of a user's movement within the sporting event session, and determining whether to combine the video data with additional video data of the user's movement that is detected. The method may also include creating a video file based on the detected video data and any additional video data of the user's movement, and playing the video file on a display device. Other example embodiments of the present application may include an apparatus configured to process recorded video of a user participating in a sporting event session. The apparatus may include a detector configured to detect video data has been created of a user's movement within the sporting event session. The apparatus may also include a processor configured to determine whether to combine the video data with additional video data of the user's movement that is detected, create a video file based on the detected video data and any additional video data of the user's movement, and play the video file on a display device.

In one embodiment, a method of processing recorded video of a user participating in a sporting event session, comprises detecting video data has been created of a user's movement within the sporting event session, determining whether to combine the video data with additional video data of the user's movement that is detected, creating a video file based on the detected video data and any additional video data of the user's movement, and playing the video file on a display device. The method further comprises adding the video data to a specified data storage memory location based on the user's identity information, wherein determining whether to combine the video data with the additional video data of the user's movement that is detected comprises matching the user's identity information corresponding to the video data with the user's identity information corresponding to the additional video data., wherein the video data comprises user movement that was captured via a first recording device and the additional video data comprises user movement that was captured via a second recording device that is different from the first recording device. The method further comprises editing the video data to insert advertisements into the video file so that the video file comprises the user's movement and advertisement data that was not previously present in the video data or the additional video data. The method further comprise publishing the video file to an Internet accessible database providing a user with a login portal access to the video file to edit and modify the video file, wherein the video file is designated as at least one of shared, not shared, saved and deleted, based on the user's identity information.

In another embodiment, an apparatus configured to process recorded video of a user participating in a sporting event session, comprises a detector configured to detect video data has been created of a user's movement within the sporting event session, and a processor configured to determine whether to combine the video data with additional video data of the user's movement that is detected, create a video file based on the detected video data and any additional video data of the user's movement, and play the video file on a display device. The apparatus further comprises a data storage memory location that stores the video data based on the user's identity information, wherein determining whether to combine the video data with the additional video data of the user's movement that is detected comprises matching the user's identity information corresponding to the video data with the user's identity information corresponding to the additional video data, wherein the video data comprises user movement that was captured via a first recording device and the additional video data comprises user movement that was captured via a second recording device that is different from the first recording device, wherein the processor is further configured to edit the video data to insert advertisements into the video file so that the video file comprises the user's movement and advertisement data that was not previously present in the video data or the additional video data, wherein the processor is further configured to publish the video file to an Internet accessible database providing a user with a login portal access to the video file to edit and modify the video file, and wherein the video file is designated as at least one of shared, not shared, saved and deleted, based on the user's identity information.

In a further embodiment, a computer readable storage medium configured to store a computer program that when executed causes a processor to perform a method of processing recorded video of a user participating in a sporting event session, the processor being further configured to perform detecting video data has been created of a user's movement within the sporting event session, determining whether to combine the video data with additional video data of the user's movement that is detected, creating a video file based on the detected video data and any additional video data of the user's movement, and playing the video file on a display device, wherein the processor is further configured to perform adding the video data to a specified data storage memory location based on the user's identity information, wherein determining whether to combine the video data with the additional video data of the user's movement that is detected comprises matching the user's identity information corresponding to the video data with the user's identity information corresponding to the additional video data, wherein the video data comprises user movement that was captured via a first recording device and the additional video data comprises user movement that was captured via a second recording device that is different from the first recording device, wherein the processor is further configured to perform editing the video data to insert advertisements into the video file so that the video file comprises the user's movement and advertisement data that was not previously present in the video data or the additional video data, wherein the processor is further configured to perform publishing the video file to an Internet accessible database providing a user with a login portal access to the video file to edit and modify the video file.

Many variations of the disclosure will occur to those skilled in the art. All such variations are intended to be within the scope and spirit of the disclosure. Although some embodiments are shown to include certain features, the applicants specifically contemplate that any feature disclosed herein may be used together or in combination with any other feature on any embodiment of the disclosure. It is also contemplated that any feature may be specifically excluded from any embodiment of a disclosure.

What is claimed is:

1. A method of recording the movement of a user during a sporting event session, the method comprising:
detecting the user's movement during a first portion of the sporting event session; and
recording the user's movement via at least one first recording device upon the user's first location being confirmed via a location determination device.

2. The method of claim 1, further comprising:
detecting the user's movement during a second portion of the sporting event session different from the first portion; and
recording the user's movement via at least one second recording device upon the user's new location being confirmed as being different from the first location via the same location determination device.

3. The method of claim 2, wherein the first location is a first predefined area of a sporting venue and the new location is a second predefined area of the same sporting venue that is different from the first predefined area.

4. The method of claim 1, further comprising:
sending a signal to the at least one first recording device to begin recording upon the user's location being confirmed and the user's identity being confirmed.

5. The method of claim 4, wherein the location determination device communicates with a device tag worn by the user in order to determine the user's identity and location.

6. The method of claim 5, wherein the device tag worn by the user is a radio frequency identification (RFID) device.

7. The method of claim 1, wherein the user's location is determined by at least one of GPS location determination and a triangulation location determination.

8. The method of claim 1, further comprising:
transmitting the recorded user movement to a server which processes the user movement data and combines the user movement with other recorded user movement data to create a video file that represents the user's run at the sporting event session; and
storing the video file in a personal profile storage location corresponding to the user.

9. An apparatus configured to record the movement of a user during a sporting event session, the apparatus comprising:
a detector configured to detect the user's movement during a first portion of the sporting event session; and
a recording device configured to record the user's movement upon the user's first location being confirmed via the location determination device.

10. The apparatus of claim 9, further comprising:
at least one second recorder configured to further record the user's movement upon a new user location being confirmed as being different from the first location via the same location determination device.

11. The apparatus of claim 10, wherein the first location is a first predefined area of a sporting venue and the new location is a second predefined area of the same sporting venue that is different from the first predefined area.

12. The apparatus of claim 9, further comprising:
a transmitter configured to send a signal to the at least one first recording device to begin recording upon the user's location being confirmed and the user's identity being confirmed.

13. The apparatus of claim 12, wherein the location determination device communicates with a device tag worn by the user in order to determine the user's identity and location.

14. The apparatus of claim 13, wherein the device tag worn by the user is a radio frequency identification (RFID) device.

15. The apparatus of claim 9, wherein the user's location is determined by at least one of GPS location determination and a triangulation location determination.

16. The apparatus of claim 9, further comprising:
a transmitter configured to transmit the recorded user movement to a server which processes the user movement data and combines the user movement with other recorded user movement data to create a video file that represents the user's run at the sporting event session; and
a memory configured to store the video file in a personal profile storage location corresponding to the user.

17. A computer readable storage medium configured to store a computer program that when executed causes a processor to perform recording the movement of a user during a sporting event session, the processor being further configured to perform:
detecting the user's movement during a first portion of the sporting event session; and
recording the user's movement via at least one first recording device upon the user's first location being confirmed via a location determination device.

18. The computer program of claim 17, wherein the processor is further configured to perform:
detecting the user's movement during a second portion of the sporting event session different from the first portion; and
recording the user's movement via at least one second recording device upon the user's new location being confirmed as being different from the first location via the same location determination device.

19. The computer program of claim 18, wherein the first location is a first predefined area of a sporting venue and the new location is a second predefined area of the same sporting venue that is different from the first predefined area.

20. The computer program of claim 17, wherein the processor is further configured to perform sending a signal to the at least one first recording device to begin recording upon the user's location being confirmed and the user's identity being confirmed.
